(19) United States
(12) Patent Application Publication
(10) Pub. No.: US 2020/0020052 A1
(43) Pub. Date: Jan. 16, 2020

(54) METHOD FOR PROVIDING ACCOMMODATION SHARING SERVICE BASED ON WEB PLATFORM AND WEB SERVER THEREFOR

(71) Applicant: W IN DOUBLE SPACE CO., Seoul (KR)

(72) Inventor: Sang Deok KIM, Daegu (KR)

(21) Appl. No.: 16/493,092

(22) PCT Filed: Mar. 6, 2018
(86) PCT No.: PCT/KR2018/002623

§ 371 Date: Sep. 11, 2019

(30) Foreign Application Priority Data
Mar. 15, 2017 (KR) 10-2017-0032620

(51) Int. Cl. G06Q 50/14; G06F 16/28; G06F 16/22; G06Q 30/06; G06Q 30/04; G06Q 10/02; G06Q 50/12

(52) U.S. Cl. CPC G06Q 50/14; G06F 16/285; G06F 16/22; G06Q 50/12; G06Q 30/04; G06Q 10/025; G06Q 30/0645

(57) ABSTRACT

A method of providing a web platform based accommodation sharing service is provided. The method includes preparing a database storing information on a plurality of lodgings; receiving accommodation requests respectively from a plurality of clients; and forming an accommodation sharing candidate group based on the accommodation requests, setting the accommodation sharing candidate group as an accommodation sharing group in response to confirming online that for each member ID, a closing date and time penalty charge for a respective lodging offered for rental and an opening date and time penalty charge for a respective lodging to be rented are deposited to a bank account designated by an administrator.

### TECHNICAL FIELD

The following description relates to a business method operable through a website, and more particularly, to a technology for providing an accommodation sharing service that enables the sharing of lodgings/lodging facilities.

### BACKGROUND ART

The whole world has now come within the daily life zone as a result of the continued advancement of the aviation transportation technology since the development of an aircraft using a gasoline engine in the early 20th century. That is, due to the elimination of the spatial limitation existed in the past era when it was not easy to travel over a long distance, travelling from continent to continent over a long distance has become part of people's daily lives. In the meantime, in case of visiting a particular place located abroad or a long distance away (i.e., a place having an earth longitude that is far away from the earth longitude of a place of departure), the overall travel expenses including, for example, airline fares for a flight to the corresponding place do not vary significantly regardless of how long the traveler stays in the corresponding place, under the condition that the same transportation means is exploited. Thus, people who visit a particular place located abroad or a long distance away tent to prefer to stay in the place for as long a period as possible, as long as they do not feel the necessary lodging expenses burdensome.

However, as a period of stay is getting longer, the incurred lodging expenses increase proportionally, with the result that the lodging expenses constitute a great part of the travel expenses and could be felt to be burdensome to the traveler. Recently, a few new business methods emerged as a means to alleviate the burden of paying costly lodging expenses. These new business methods include a business method of renting accommodation such as a house owned by a general person, rather than a room provided by a lodging business, at an affordable rate and a business method of enabling general persons to use others' accommodation in exchange for their own accommodation. These business methods can provide the advantages that accommodation can be rented with relatively cheap lodging fees compared to those to be payed when using a room provided by an existing lodging business. However, these methods proved to be inadequate in having accommodation owned by general persons shared with one another to thereby alleviate the burden of paying costly lodging expenses.

### DETAILED DESCRIPTION OF THE INVENTION

### Technical Problem

A problem to be solved by the disclosed technology is to provide a method of providing accommodation sharing services and a web server therefor that can alleviate the burden of paying costly lodging expenses by enabling the sharing of lodgings/lodging facilities among travelers.

Another problem to be solved by the disclosed technology is to provide a method of providing accommodation sharing services and a web server therefor that can ensure accommodation to be provided or given back at a promised date and time.

Problems to be solved by the disclosed technology are not limited to the above-mentioned problems, and other problems not mentioned above will be appreciated by those skilled in the art from the descriptions provided below.

### Technical Solution

In one general aspect, a method of providing a web platform based accommodation sharing service includes preparing a database storing information on a plurality of lodgings; receiving accommodation requests respectively from a plurality of clients, each of the accommodation requests including information indicating at least one of the plurality of lodgings; and forming an accommodation sharing candidate group based on the accommodation requests, said accommodation sharing candidate group being identified by a group identification (ID), said group ID being associated with a plurality of member identifications (IDs), and said plurality of member IDs identifying two or more of the plurality of clients. The forming an accommodation sharing candidate group comprises storing member information associated with each of the plurality of member IDs, said member information associated with each of the plurality of member IDs including information on an opening date and time for a lodging offered for rental, a closing date and time for the lodging offered for rental, an opening date and time for a lodging to be rented, a closing date and time for the lodging to be rented, an opening date and time penalty charge for the lodging offered for rental, a closing date and time penalty charge for the lodging offered for rental, an opening date and time penalty charge for the lodging to be rented, and a closing date and time penalty charge for the lodging to be rented, and said member information associated with each of the plurality of member IDs further including information on a bank account associated with the respective member ID. The method further includes setting the accommodation sharing candidate group as an accommodation sharing group in response to confirming online that for each of the plurality of member IDs, the closing date and time penalty charge for the respective lodging offered for rental and the opening date and time penalty charge for the respective lodging to be rented are deposited to a bank account designated by an administrator; and if an alarm message is not received from a client identified by a particular member ID associated with the group ID of the accommodation sharing group within a predetermined period of time from the closing date and time for the respective lodging offered for rental, said alarm message notifying that the respective lodging offered for rental is closed, and if a message including identification information identifying the particular member ID is received from an administrator terminal or a message including administrator identification information is received from the client identified by the particular member ID, controlling the closing date and time penalty charge for the respective lodging offered for rental to be deposited online to the bank account associated with the particular member ID.

In an example, the controlling the closing date and time penalty charge for the respective lodging offered for rental to be deposited online to the bank account associated with the particular member ID may comprise transmitting, to the administrator terminal, a command message commanding to visit the respective lodging offered for rental if the alarm message is not received from the client identified by the particular member ID associated with the group ID of the accommodation sharing group within the predetermined period of time from the closing date and time for the respective lodging offered for rental.

In an example, the lodging to be rented may be a lodging offered by a client identified by any one member ID of the plurality of member IDs, and the information on the plurality of lodgings may comprise information on the lodging offered for rental and information on the lodging to be rented.

In an example, the method may further comprise transmitting, to a client identified by each of the plurality of member IDs, a guidance message for requesting to deposit the opening date and time penalty charge for the respective lodging offered for rental and the closing date and time penalty charge for the respective lodging to be rented to the bank account designated by the administrator.

In an example, the method may further comprise: if an alarm message is not received from the client identified by the particular member ID within a predetermined period of time from the opening date and time for the respective lodging to be rented, said alarm message notifying that the respective lodging to be rented is opened from the opening date and time for the respective lodging to be rented, and if a message including the identification information identifying the particular member ID is received from the administrator terminal or a message including the administrator identification information is received from the client identified by the particular member ID, controlling the opening date and time penalty charge for the respective lodging to be rented to be deposited online to the bank account associated with the particular member ID.

In an example, the forming an accommodation sharing candidate group based on the accommodation requests may comprise receiving, from at least one of the two or more clients respectively identified by the plurality of member IDs, information on the closing date and time penalty charge for the respective lodging offered for rental.

In an example, the forming an accommodation sharing candidate group based on the accommodation requests may comprise receiving, from at least one of the two or more clients respectively identified by the plurality of member IDs, information on the opening date and time penalty charge for the respective lodging offered for rental.

In an example, the receiving, from each of the two or more clients respectively identified by the plurality of member IDs, information on the closing date and time penalty charge for the respective lodging offered for rental may comprise providing, to each of the two or more clients respectively identified by the plurality of member IDs, information on a lodging fee for at least one nearby lodging facility located within a predetermined distance from the respective lodging offered for rental.

In an example, the receiving, from each of the two or more clients respectively identified by the plurality of member IDs, information on the opening date and time penalty charge for the respective lodging offered for rental may comprise providing, to each of the two or more clients respectively identified by the plurality of member IDs, information on a lodging fee for at least one nearby lodging facility located within a predetermined distance from the respective lodging offered for rental.

In an example, the identification information identifying the particular member ID may be any one selected from the group consisting of a password identifying the particular member ID, fingerprint information identifying the particular member ID, blood vessel information identifying the particular member ID, iris information identifying the particular member ID, retina information identifying the particular member ID, voice information identifying the particular member ID, image information identifying the particular member ID, signature information identifying the particular member ID, text information identifying the particular member ID, sound information identifying the particular member ID, and encryption information obtained by encrypting the password identifying the particular member ID, the fingerprint information identifying the particular member ID, the blood vessel information identifying the particular member ID, the iris information identifying the particular member ID, the retina information identifying the particular member ID, the voice information identifying the particular member ID, the image information identifying the particular member ID, the signature information identifying the particular member ID, the text information identifying the particular member ID or the sound information identifying the particular member ID.

In an example, the accommodation sharing candidate group may be one of a one hop lodging candidate group for one hop accommodation sharing, a two hop lodging candidate group for two hop accommodation sharing, and a three hop lodging candidate group for three hop accommodation sharing.

In another general aspect, a method of providing a web platform based accommodation sharing service includes preparing a database storing information on a plurality of lodgings; receiving accommodation requests respectively from a plurality of clients, each of the accommodation requests including information indicating at least one of the plurality of lodgings; and forming an accommodation sharing candidate group based on the accommodation requests, said accommodation sharing candidate group being identified by a group identification

(ID), said group ID being associated with a plurality of member identifications (IDs), and said plurality of member IDs identifying two or more of the plurality of clients. The forming an accommodation sharing candidate group comprises storing member information associated with each of the plurality of member IDs, said member information associated with each of the plurality of member IDs including information on an opening date and time for a lodging offered for rental, a closing date and time for the lodging offered for rental, an opening date and time for a lodging to be rented, a closing date and time for the lodging to be rented, an opening date and time penalty charge for the lodging offered for rental, a closing date and time penalty charge for the lodging offered for rental, an opening date and time penalty charge for the lodging to be rented, and a closing date and time penalty charge for the lodging to be rented, and said member information associated with each of the plurality of member IDs further including information on a bank account associated with the respective member ID. The method further includes setting the accommodation sharing candidate group as an accommodation sharing group in response to confirming online that for each of the plurality of member IDs, the closing date and time penalty charge for the respective lodging offered for rental and the opening date and time penalty charge for the respective lodging to be rented are deposited to a bank account designated by an administrator; and if an alarm message is not received from a client identified by a particular member ID associated with the group ID of the accommodation sharing group within a predetermined period of time from the opening date and time for the respective lodging to be rented, said alarm message notifying that the respective lodging to be rented is opened, and if a message including identification information identifying the particular member ID is received from an administrator terminal or a message including administrator identification information is received from the client identified by the particular member ID, controlling the opening date and time penalty charge for the respective lodging to be rented to be deposited online to the bank account associated with the particular member ID.

In an example, the controlling the opening date and time penalty charge for the respective lodging to be rented to be deposited online to the bank account associated with the particular member ID may comprise transmitting, to the administrator terminal, a command message commanding to visit the respective lodging to be rented if the alarm message is not received from the client identified by the particular member ID associated with the group ID of the accommodation sharing group within the predetermined period of time from the opening date and time for the respective lodging to be rented.

In an example, the lodging to be rented may be a lodging offered by a client identified by any one member ID of the plurality of member IDs, and the information on the plurality of lodgings comprises information on the lodging offered for rental and information on the lodging to be rented.

In an example, the method may further comprise transmitting, to a client identified by each of the plurality of member IDs, a guidance message for requesting to deposit the opening date and time penalty charge for the respective lodging offered for rental and the closing date and time penalty charge for the respective lodging to be rented to the bank account designated by the administrator.

In an example, the method may further comprise: if an alarm message is not received from the client identified by the particular member ID within a predetermined period of time from the closing date and time for the respective lodging offered for rental, said alarm message notifying that the respective lodging offered for rental is closed from the closing date and time for the respective lodging offered for rental, and if a message including the identification information identifying the particular member ID is received from the administrator terminal or a message including the administrator identification information is received from the client identified by the particular member ID, controlling the closing date and time penalty charge for the respective lodging offered for rental to be deposited online to the bank account associated with the particular member ID.

In an example, the forming an accommodation sharing candidate group based on the accommodation requests may comprise receiving, from at least one of the two or more clients respectively identified by the plurality of member IDs, information on the closing date and time penalty charge for the respective lodging offered for rental.

In an example, the forming an accommodation sharing candidate group based on the accommodation requests may comprise receiving, from at least one of the two or more clients respectively identified by the plurality of member IDs, information on the opening date and time penalty charge for the respective lodging offered for rental.

In an example, the receiving, from each of the two or more clients respectively identified by the plurality of member IDs, information on the closing date and time penalty charge for the respective lodging offered for rental may comprise providing, to each of the two or more clients respectively identified by the plurality of member IDs, information on a lodging fee for at least one nearby lodging facility located within a predetermined distance from the respective lodging offered for rental.

In an example, the receiving, from each of the two or more clients respectively identified by the plurality of member IDs, information on the opening date and time penalty charge for the respective lodging offered for rental may comprise providing, to each of the two or more clients respectively identified by the plurality of member IDs, information on a lodging fee for at least one nearby lodging facility located within a predetermined distance from the respective lodging offered for rental.

In an example, the identification information identifying the particular member ID may be any one selected from the group consisting of a password identifying the particular member ID, fingerprint information identifying the particular member ID, blood vessel information identifying the particular member ID, iris information identifying the particular member ID, retina information identifying the particular member ID, voice information identifying the particular member ID, image information identifying the particular member ID, signature information identifying the particular member ID, text information identifying the particular member ID, sound information identifying the particular member ID, and encryption information obtained by encrypting the password identifying the particular member ID, the fingerprint information identifying the particular member ID, the blood vessel information identifying the particular member ID, the iris information identifying the particular member ID, the retina information identifying the particular member ID, the voice information identifying the particular member ID, the image information identifying the particular member ID, the signature information identifying the particular member ID, the text information identifying the particular member ID or the sound information identifying the particular member ID.

In an example, the accommodation sharing candidate group may be one of a one hop lodging candidate group for one hop accommodation sharing, a two hop lodging candidate group for two hop accommodation sharing, and a three hop lodging candidate group for three hop accommodation sharing.

In another general aspect, a method of providing a web platform based accommodation sharing service includes preparing a database storing information on a plurality of lodgings; receiving accommodation requests respectively from a plurality of clients, each of the accommodation requests including information indicating at least one of the plurality of lodgings; and forming an accommodation sharing candidate group based on the accommodation requests, said accommodation sharing candidate group being identified by a group identification

(ID), said group ID being associated with a plurality of member identifications (IDs), and said plurality of member IDs identifying two or more of the plurality of clients. The forming an accommodation sharing candidate group comprises storing member information associated with each of the plurality of member IDs, said member information associated with each of the plurality of member IDs including information on an arrangement/equipment defect penalty charge for a lodging offered for rental, an arrangement/equipment defect penalty charge for a lodging to be rented, and a bank account associated with the respective member ID. The method further includes setting the accommodation sharing candidate group as an accommodation sharing group in response to confirming online that for each of the plurality of member IDs, the arrangement/equipment defect penalty charge for the respective lodging to be rented is deposited to a bank account designated by an administrator; and if an alarm message is received from a client identified by a particular member ID associated with the group ID of the accommodation sharing group, said alarm message notifying that a defect is present in an arrangement or equipment of the respective lodging to be rented, and if a message including identification information identifying the particular member ID is received from an administrator terminal or a message including administrator identification information is received from the client identified by the particular member ID, controlling the arrangement/equipment defect penalty charge for the respective lodging to be rented to be deposited online to the bank account associated with the particular member ID.

In an example, the lodging to be rented may be a lodging offered by a client identified by any one member ID of the plurality of member IDs, and the information on the plurality of lodgings comprises information on the lodging offered for rental and information on the lodging to be rented.

In an example, the method may further comprise transmitting, to a client identified by each of the plurality of member IDs, a guidance message for requesting to deposit the arrangement/equipment defect penalty charge for the respective lodging offered for rental to the bank account designated by the administrator.

In an example, the forming an accommodation sharing candidate group based on the accommodation requests may comprise receiving, from at least one of the two or more clients respectively identified by the plurality of member IDs, information on the arrangement/equipment defect penalty charge for the respective lodging offered for rental.

In an example, the receiving, from each of the two or more clients respectively identified by the plurality of member IDs, information on the arrangement/equipment defect penalty charge for the respective lodging offered for rental may comprise providing, to each of the two or more clients respectively identified by the plurality of member IDs, information on a lodging fee for at least one nearby lodging facility located within a predetermined distance from the respective lodging offered for rental.

In an example, the identification information identifying the particular member ID may be any one selected from the group consisting of a password identifying the particular member ID, fingerprint information identifying the particular member ID, blood vessel information identifying the particular member ID, iris information identifying the particular member ID, retina information identifying the particular member ID, voice information identifying the particular member ID, image information identifying the particular member ID, signature information identifying the particular member ID, text information identifying the particular member ID, sound information identifying the particular member ID, and encryption information obtained by encrypting the password identifying the particular member ID, the fingerprint information identifying the particular member ID, the blood vessel information identifying the particular member ID, the iris information identifying the particular member ID, the retina information identifying the particular member ID, the voice information identifying the particular member ID, the image information identifying the particular member ID, the signature information identifying the particular member ID, the text information identifying the particular member ID or the sound information identifying the particular member ID.

In an example, the accommodation sharing candidate group may be one of a one hop lodging candidate group for one hop accommodation sharing, a two hop lodging candidate group for two hop accommodation sharing, and a three hop lodging candidate group for three hop accommodation sharing.

In another general aspect, a web server for providing an accommodation sharing service includes a database storing information on a plurality of lodgings; a communication unit configured to receive accommodation requests respectively from a plurality of clients, each of the accommodation requests including information indicating at least one of the plurality of lodgings; and a control unit operatively coupled to the database and configured to form an accommodation sharing candidate group based on the accommodation requests, said accommodation sharing candidate group being identified by a group identification (ID), said group ID being associated with a plurality of member identifications (IDs), and said plurality of member IDs identifying two or more of the plurality of clients. The database further stores member information associated with each of the plurality of member IDs, said member information associated with each of the plurality of member IDs including information on an opening date and time for a lodging offered for rental, a closing date and time for the lodging offered for rental, an opening date and time for a lodging to be rented, a closing date and time for the lodging to be rented, an opening date and time penalty charge for the lodging offered for rental, a closing date and time penalty charge for the lodging offered for rental, an opening date and time penalty charge for the lodging to be rented, and a closing date and time penalty charge for the lodging to be rented, and said member information associated with each of the plurality of member IDs further including information on a bank account associated with the respective member ID. The control unit is further configured to set the accommodation sharing candidate group as an accommodation sharing group in response to confirming online that for each of the plurality of member IDs, the closing date and time penalty charge for the respective lodging offered for rental and the opening date and time penalty charge for the respective lodging to be rented are deposited to a bank account designated by an administrator. The control unit is further configured to control an online banking transaction to be effected if first predetermined conditions are met, said first predetermined conditions including a first condition that an alarm message is not received through the communication unit from a client identified by a particular member ID associated with the group ID of the accommodation sharing group within a predetermined period of time from the closing date and time for the respective lodging offered for rental, said alarm message notifying that the respective lodging offered for rental is closed, said first predetermined conditions further including a second condition that a message including identification information identifying the particular member ID is received through the communication unit from an administrator terminal or a message including administrator identification information is received through the communication unit from the client identified by the particular member ID, and said online banking transaction including an online deposit transaction for depositing the closing date and time penalty charge for the respective lodging offered for rental to the bank account associated with the particular member ID.

In an example, the lodging to be rented may be a lodging offered by a client identified by any one member ID of the plurality of member IDs, and the information on the plurality of lodgings comprises information on the lodging offered for rental and information on the lodging to be rented.

In an example, the control unit may be further configured to transmit, through the communication unit to a client identified by each of the plurality of member IDs, a guidance message for requesting to deposit the opening date and time penalty charge for the respective lodging offered for rental and the closing date and time penalty charge for the respective lodging to be rented to the bank account designated by the administrator.

In an example, the control unit may be further configured to control an online banking transaction to be effected if second predetermined conditions are met, said second predetermined conditions including a third condition that an alarm message is not received through the communication unit from the client identified by the particular member ID within a predetermined period of time from the opening date and time for the respective lodging to be rented, said alarm message notifying that the respective lodging to be rented is opened from the opening date and time for the respective lodging to be rented, said second predetermined conditions further including a fourth condition that a message including the identification information identifying the particular member ID is received through the communication unit from the administrator terminal or a message including the administrator identification information is received through the communication unit from the client identified by the particular member ID, and said online banking transaction including an online deposit transaction for depositing the opening date and time penalty charge for the respective lodging to be rented to the bank account associated with the particular member ID.

In an example, the communication unit may be further configured to receive, from at least one of the two or more clients respectively identified by the plurality of member IDs, a message including information on the closing date and time penalty charge for the respective lodging offered for rental.

In an example, the communication unit may be further configured to receive, from at least one of the two or more clients respectively identified by the plurality of member IDs, a message including information on the opening date and time penalty charge for the respective lodging offered for rental.

In an example, the control unit may be further configured to provide, through the communication unit to each of the two or more clients respectively identified by the plurality of member IDs, information on a lodging fee for at least one nearby lodging facility located within a predetermined distance from the respective lodging offered for rental.

In an example, the identification information identifying the particular member ID may be any one selected from the group consisting of a password identifying the particular member ID, fingerprint information identifying the particular member ID, blood vessel information identifying the particular member ID, iris information identifying the particular member ID, retina information identifying the particular member ID, voice information identifying the particular member ID, image information identifying the particular member ID, signature information identifying the particular member ID, text information identifying the particular member ID, sound information identifying the particular member ID, and encryption information obtained by encrypting the password identifying the particular member ID, the fingerprint information identifying the particular member ID, the blood vessel information identifying the particular member ID, the iris information identifying the particular member ID, the retina information identifying the particular member ID, the voice information identifying the particular member ID, the image information identifying the particular member ID, the signature information identifying the particular member ID, the text information identifying the particular member ID or the sound information identifying the particular member ID.

In an example, the accommodation sharing candidate group may be one of a one hop lodging candidate group for one hop accommodation sharing, a two hop lodging candidate group for two hop accommodation sharing, and a three hop lodging candidate group for three hop accommodation sharing.

In another general aspect, a web server for providing an accommodation sharing service includes a database storing information on a plurality of lodgings; a communication unit configured to receive accommodation requests respectively from a plurality of clients, each of the accommodation requests including information indicating at least one of the plurality of lodgings; and a control unit operatively coupled to the database and configured to form an accommodation sharing candidate group based on the accommodation requests, said accommodation sharing candidate group being identified by a group identification (ID), said group ID being associated with a plurality of member identifications (IDs), and said plurality of member IDs identifying two or more of the plurality of clients. The database further stores member information associated with each of the plurality of member IDs, said member information associated with each of the plurality of member IDs including information on an opening date and time for a lodging offered for rental, a closing date and time for the lodging offered for rental, an opening date and time for a lodging to be rented, a closing date and time for the lodging to be rented, an opening date and time penalty charge for the lodging offered for rental, a closing date and time penalty charge for the lodging offered for rental, an opening date and time penalty charge for the lodging to be rented, and a closing date and time penalty charge for the lodging to be rented, and said member information associated with each of the plurality of member IDs further including information on a bank account associated with the respective member ID. The control unit is further configured to set the accommodation sharing candidate group as an accommodation sharing group in response to confirming online that for each of the plurality of member IDs, the closing date and time penalty charge for the respective lodging offered for rental and the opening date and time penalty charge for the respective lodging to be rented are deposited to a bank account designated by an administrator. The control unit is further configured to control an online banking transaction to be effected if first predetermined conditions are met, said first predetermined conditions including a first condition that an alarm message is not received through the communication unit from a client identified by a particular member ID associated with the group ID of the accommodation sharing group within a predetermined period of time from the opening date and time for the respective lodging to be rented, said alarm message notifying that the respective lodging to be rented is opened, said first predetermined conditions further including a second condition that a message including identification information identifying the particular member ID is received through the communication unit from an administrator terminal or a message including administrator identification information is received through the communication unit from the client identified by the particular member ID, and said online banking transaction including an online deposit transaction for depositing the opening date and time penalty charge for the respective lodging to be rented to the bank account associated with the particular member ID.

In an example, the lodging to be rented may be a lodging offered by a client identified by any one member ID of the plurality of member IDs, and the information on the plurality of lodgings comprises information on the lodging offered for rental and information on the lodging to be rented.

In an example, the control unit may be further configured to transmit, through the communication unit to a client identified by each of the plurality of member IDs, a guidance message for requesting to deposit the opening date and time penalty charge for the respective lodging offered for rental and the closing date and time penalty charge for the respective lodging to be rented to the bank account designated by the administrator.

In an example, the control unit may be further configured to control an online banking transaction to be effected if second predetermined conditions are met, said second predetermined conditions including a third condition that an alarm message is not received through the communication unit from the client identified by the particular member ID within a predetermined period of time from the closing date and time for the respective lodging offered for rental, said alarm message notifying that the respective lodging offered for rental is closed from the closing date and time for the respective lodging offered for rental, said second predetermined conditions further including a fourth condition that a message including the identification information identifying the particular member ID is received through the communication unit from the administrator terminal or a message including the administrator identification information is received through the communication unit from the client identified by the particular member ID, and said online banking transaction including an online deposit transaction for depositing the closing date and time penalty charge for the respective lodging offered for rental to the bank account associated with the particular member ID.

In an example, the communication unit may be further configured to receive, from at least one of the two or more clients respectively identified by the plurality of member IDs, a message including information on the closing date and time penalty charge for the respective lodging offered for rental.

In an example, the communication unit may be further configured to receive, from at least one of the two or more clients respectively identified by the plurality of member IDs, a message including information on the opening date and time penalty charge for the respective lodging offered for rental.

In an example, the control unit may be further configured to provide, through the communication unit to each of the two or more clients respectively identified by the plurality of member IDs, information on a lodging fee for at least one nearby lodging facility located within a predetermined distance from the respective lodging offered for rental.

In an example, the identification information identifying the particular member ID may be any one selected from the group consisting of a password identifying the particular member ID, fingerprint information identifying the particular member ID, blood vessel information identifying the particular member ID, iris information identifying the particular member ID, retina information identifying the particular member ID, voice information identifying the particular member ID, image information identifying the particular member ID, signature information identifying the particular member ID, text information identifying the particular member ID, sound information identifying the particular member ID, and encryption information obtained by encrypting the password identifying the particular member ID, the fingerprint information identifying the particular member ID, the blood vessel information identifying the particular member ID, the iris information identifying the particular member ID, the retina information identifying the particular member ID, the voice information identifying the particular member ID, the image information identifying the particular member ID, the signature information identifying the particular member ID, the text information identifying the particular member ID or the sound information identifying the particular member ID.

In an example, the accommodation sharing candidate group may be one of a one hop lodging candidate group for one hop accommodation sharing, a two hop lodging candidate group for two hop accommodation sharing, and a three hop lodging candidate group for three hop accommodation sharing.

In another general aspect, a web server for providing an accommodation sharing service includes a database storing information on a plurality of lodgings; a communication unit configured to receive accommodation requests respectively from a plurality of clients, each of the accommodation requests including information indicating at least one of the plurality of lodgings; and a control unit operatively coupled to the database and configured to form an accommodation sharing candidate group based on the accommodation requests, said accommodation sharing candidate group being identified by a group identification (ID), said group ID being associated with a plurality of member identifications (IDs), and said plurality of member IDs identifying two or more of the plurality of clients. The database further stores member information associated with each of the plurality of member IDs, said member information associated with each of the plurality of member IDs including information on an arrangement/equipment defect penalty charge for a lodging offered for rental, an arrangement/equipment defect penalty charge for a lodging to be rented, and a bank account associated with the respective member ID. The control unit is further configured to set the accommodation sharing candidate group as an accommodation sharing group in response to confirming online that for each of the plurality of member IDs, the arrangement/equipment defect penalty charge for the respective lodging to be rented is deposited to a bank account designated by an administrator. The control unit is further configured to control an online banking transaction to be effected if predetermined conditions are met, said predetermined conditions including a first condition that an alarm message is received through the communication unit from a client identified by a particular member ID associated with the group ID of the accommodation sharing group, said alarm message notifying that a defect is present in an arrangement or equipment of the respective lodging to be rented, said predetermined conditions further including a second condition that a message including identification information identifying the particular member ID is received through the communication unit from an administrator terminal or a message including administrator identification information is received through the communication unit from the client identified by the particular member ID, and said online banking transaction including an online deposit transaction for depositing the arrangement/equipment defect penalty charge for the respective lodging to be rented to the bank account associated with the particular member ID.

In an example, the lodging to be rented may be a lodging offered by a client identified by any one member ID of the plurality of member IDs, and the information on the plurality of lodgings comprises information on the lodging offered for rental and information on the lodging to be rented.

In an example, the control unit may be further configured to transmit, through the communication unit to a client identified by each of the plurality of member IDs, a guidance message for requesting to deposit the arrangement/equipment defect penalty charge for the respective lodging offered for rental to the bank account designated by the administrator.

In an example, the communication unit may be further configured to receive, from at least one of the two or more clients respectively identified by the plurality of member IDs, a message including information on the arrangement/equipment defect penalty charge for the respective lodging offered for rental.

In an example, the control unit may be further configured to provide, through the communication unit to each of the two or more clients respectively identified by the plurality of member IDs, information on a lodging fee for at least one nearby lodging facility located within a predetermined distance from the respective lodging offered for rental.

In an example, the identification information identifying the particular member ID may be any one selected from the group consisting of a password identifying the particular member ID, fingerprint information identifying the particular member ID, blood vessel information identifying the particular member ID, iris information identifying the particular member ID, retina information identifying the particular member ID, voice information identifying the particular member ID, image information identifying the particular member ID, signature information identifying the particular member ID, text information identifying the particular member ID, sound information identifying the particular member ID, and encryption information obtained by encrypting the password identifying the particular member ID, the fingerprint information identifying the particular member ID, the blood vessel information identifying the particular member ID, the iris information identifying the particular member ID, the retina information identifying the particular member ID, the voice information identifying the particular member ID, the image information identifying the particular member ID, the signature information identifying the particular member ID, the text information identifying the particular member ID or the sound information identifying the particular member ID.

In an example, the accommodation sharing candidate group may be one of a one hop lodging candidate group for one hop accommodation sharing, a two hop lodging candidate group for two hop accommodation sharing, and a three hop lodging candidate group for three hop accommodation sharing.

In another general aspect, a method of providing a web platform based accommodation sharing service includes forming an accommodation sharing candidate group based on accommodation requests received from a plurality of clients, said accommodation sharing candidate group being identified by a group identification (ID), said group ID being associated with a plurality of member identifications (IDs), and said plurality of member IDs identifying two or more of the plurality of clients, and collecting member information associated with each of the plurality of member IDs. The member information associated with each of the plurality of member IDs includes information on an opening date and time penalty charge for a lodging offered for rental, an opening date and time penalty charge for a lodging to be rented, and a bank account associated with the respective member ID. The method further includes setting the accommodation sharing candidate group as an accommodation sharing group in response to confirming online that for each of the plurality of member IDs, the opening date and time penalty charge for the respective lodging offered for rental is deposited to a bank account designated by an administrator; and in response to receiving, from a client identified by each of the plurality of member IDs associated with the group ID of the accommodation sharing group, a payment request to pay the opening date and time penalty charge for the respective lodging to be rented, controlling the opening date and time penalty charge for the respective lodging to be rented to be deposited online to the bank account associated with the respective member ID based on the payment request.

### Advantageous Effects of the Invention

According to the examples of the disclosed technology, lodgings can be shared among travelers and/or lodging providers to alleviate the travelers' burden of paying costly lodging expenses.

### BRIEF DESCRIPTION OF THE DRAWINGS

FIG. 1 is a view illustrating a network diagram where a web server for providing an accommodation sharing service according to an example of the disclosed technology is connected to clients and an administrator terminal.

FIG. 2 is a view illustrating an example of a block diagram of the web server shown in FIG. 1.

FIG. 3 is a view illustrating an exemplary manner of forming an accommodation sharing candidate group according to an example of the disclosed technology.

FIG. 4 is a view illustrating another exemplary manner of forming an accommodation sharing candidate group according to an example of the disclosed technology.

FIG. 5 is a view illustrating yet another exemplary manner of forming an accommodation sharing candidate group according to an example of the disclosed technology.

FIG. 6 is a view illustrating an example of a flowchart for explaining a process of setting an accommodation sharing group in implementing a method of providing a web platform based accommodation sharing service according to an example of the disclosed technology.

FIG. 7 is a view illustrating an example of a flowchart for explaining a process of paying a closing date and time penalty charge for a lodging offered for rental, which is executed when the lodging offered for rental is not closed at a preset closing date and time, in implementing a method of providing a web platform based accommodation sharing service according to an example of the disclosed technology.

FIG. 8 is a view illustrating an example of a flowchart for explaining a process of paying an opening date and time penalty charge for a lodging to be rented, which is executed when the lodging to be rented is not opened at a preset opening date and time, in implementing a method of providing a web platform based accommodation sharing service according to an example of the disclosed technology.

FIG. 9 is a view illustrating an example of a flowchart for explaining a process of paying an arrangement/equipment defect penalty charge for a lodging to be rented, which is executed when a defect is present in an arrangement or equipment of the lodging to be rented, in implementing a method of providing a web platform based accommodation sharing service according to an example of the disclosed technology.

### MODES FOR CARRYING OUT THE INVENTION

The advantages and features of the disclosed technology, and methods of achieving the same will become more apparent by referring to the examples described in detail in conjunction with the accompanying drawings. However, the disclosed technology is not limited to the examples disclosed below and may be embodied in various different forms. The examples provided herein are intended to make the disclosure provided herein complete and are provided to assist those skilled in the relevant art in gaining a complete understanding of the scope of the disclosed technology. The disclosed technology is to be defined only by the scope of the claims.

The terminology used herein is for describing particular examples only, and is not to be used to limit the disclosure. For example, the articles “a,” “an,” and “the” are to be understood to include the plural forms as well, unless the context clearly indicates otherwise. The terms “comprises” and “has” specify the presence of stated features, numbers, operations, actions, elements, parts or combinations thereof, but do not preclude the presence or addition of one or more other features, numbers, operations, actions, elements, parts or combinations thereof. Also, the term “module” or “unit” as used in conjunction with the examples provided herein specifies a functional part that implements at least one function or action.

Furthermore, as used herein, all terminologies, including technical and scientific terms, have the same meaning as would be generally understood by those skilled in the art to which the disclosed technology pertains unless a different definition is provided. General terms and phrases whose definitions are provided in a common dictionary are to be understood to have the meanings consistent with those given in the context of the relevant art, and are not to be construed to have ideal or excessively formal meanings, unless another definition is explicitly provided herein.

Hereinafter, examples of the disclosed technology will be described in detail with reference to the accompanying drawings. However, in the following description of the disclosed technology, when there is a risk of a description of a known function or configuration obscuring the gist of the disclosed technology, such a description of the known function or configuration is omitted.

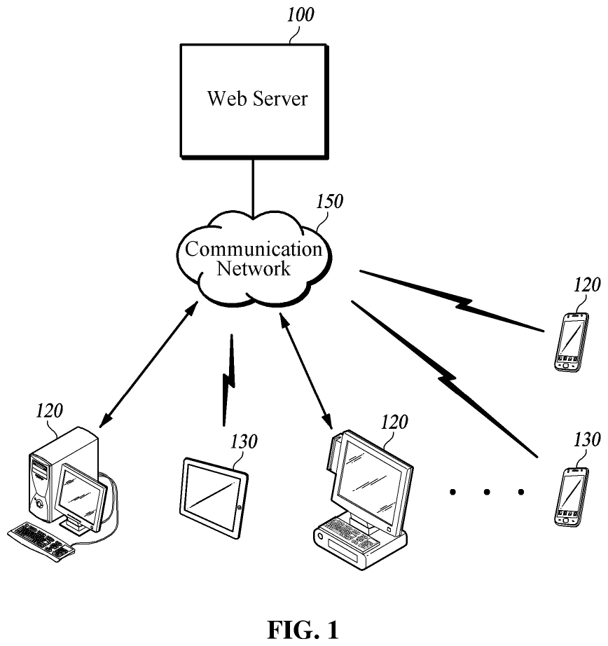

FIG. 1 is a view illustrating a network diagram where a web server for providing an accommodation sharing service according to an example of the disclosed technology is connected to clients and an administrator terminal.

As shown in FIG. 1, travelers may connect through a communication network 150 to a web server 100 for providing an accommodation sharing service according to an example of the disclosed technology by using clients 120. Once the connection is made between the travelers (clients) and the web server 100, the travelers may browse web pages/windows provided by the web server 100 to obtain information on lodgings/lodging facilities or to transmit accommodation requests to the web server 100. The travelers may also connect through the communication network 150 to the web server 100 by using the clients 120 to transmit various messages needed to implement the examples of the disclosed technology to the web server 100. The web server 100 may include a wide variety of software/programs that are installed on a hardware platform and executed to provide an accommodation sharing service according to the examples of the disclosed technology. The web server 100 may be implemented by at least one server grade computer that may include one or more proxy server. In an example, the web server 100 may be implemented by a PC-cluster based server such as a load balancing PC-cluster server. In an example, the web server 100 may be implemented by a collocated server, such as a dedicated server, a hosting server or a cloud server. In this disclosure, the term “client” is used to refer to a client terminal, but it may also refer to an owner of a lodging who is using a client terminal and/or a traveler, depending on the context. In an example, the client 120 may include a desktop or laptop PC having a wireless LAN module and/or a wired LAN module, a portable terminal such as a tablet PC, a notebook, a notepad, etc., a wide range of handheld based wireless communication devices such as a smart phone, etc., a workstation, a smart TV such as an Internet Protocol Television (IPTV), an Internet television, a terrestrial TV, a cable TV, etc., but is not limited thereto. An administrator terminal 130 may be a terminal operated in travel areas where the travelers, who subscribed to a web service according to an example of the disclosed technology, are traveling, i.e., areas near the places where the lodgings/lodging facilities are located. The administrator terminal 130 may be a terminal carried by an administrator who is operating the web server 100 or persons under the administrator's control, and may be used in transmitting a message including identification information that the traveler inputs to identify himself. The administrator terminal 130 may include a portable terminal such as a tablet PC, a notebook, a notepad, etc. and a wide range of handheld based wireless communication devices such as a smart phone, etc., but is not limited thereto.

In an example, the client 120 may have a web browser and may be configured to access the web server 100 through the communication network 150 to browse and retrieve web pages provided by the web server 100 using the web browser. The web browser running in the client 120 may include a web browser for a PC, such as Opera, FireFox, Safari, Internet Explorer, Microsoft Edge, Google Chrome, Navigator, etc., or a web browser for a mobile device, such as Opera Mini, FireFox Mobile, Mobile Safari, Google Mobile, etc. The client 120 may include an application program(s) and/or a plug-in(s) running therein that is supplied through the communication network 150 by the web server 100.

The communication network 150 may include one of existing wired/wireless networks, such as the Internet, a Wireless Internet Platform for Interoperability (WIFI) network, a Local Area Network (LAN), a Wide Area Network (WAN), a Value Added Network (VAN), a Personal Area Network (PAN), a Personal Communication System (PCS) network, a Global System for Mobile communications (GSM) network, a Personal Digital Cellular (PDC) network, a Personal Handy-phone System (PHS) network, a Personal Digital Assistant (PDA) network, an International Mobile Telecommunication-2000 (IMT-2000) network, a Code Division Multiple Access-2000 (CDMA-2000) network, a Wideband Code Division Multiple Access (W-CDMA) network, a Wireless Broadband Internet (Wibro) network, a 4G network (LTE/LTE-Advanced), a satellite communication network, etc., but is not limited thereto.

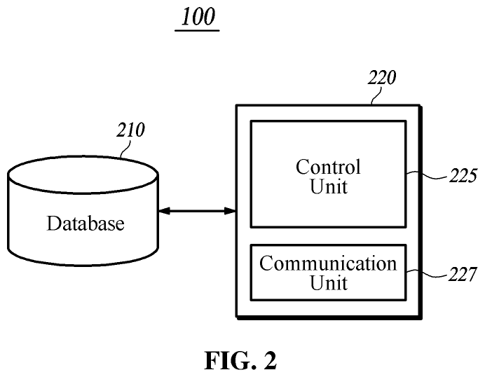

FIG. 2 is a view illustrating an example of a block diagram of the web server shown in FIG. 1.

As shown, the web server 100 for providing an accommodation sharing service according to an example of the disclosed technology may include a database 210. The database 210 may store information on a plurality of lodgings. If each of the clients 120 uploads information on a lodging offered for rental by himself to the web server 100 through web pages, windows, etc. provided by the web server 100, such information may be stored in the database 210. In an example, the lodging may be a house the client himself resides in or at least one room included in the corresponding house, but is not limited thereto. The information on the lodging offered for rental by the client himself may include information on an area the corresponding lodging belongs to (a country/city or a specific address), a type of the corresponding lodging (a house, officetel, apartment, etc.), a rental period for the corresponding lodging (an opening date and time and a closing date and time), and an arrangement(s), equipment and/or a convenient facility(ies) included in the corresponding lodging, a photo(s) of the corresponding lodging, etc. In an example, the database 210 may be embodied by a disk drive, a magnetic disk, an optical disk or any other appropriate memory devices.

The web server 100 may further include a host system 220. The host system 220 may include a communication unit 227. The communication unit 227 may be configured to receive accommodation requests respectively form the plurality of clients 120. The communication unit 227 may receive the accommodation requests sporadically. Each of the accommodation requests may include information indicating at least one of the plurality of lodgings whose information are stored in the database 210. In an example, the client 120-1 may transmit, to the web server 100, an accommodation request with lodgings located in London, England and Paris, France being indicated as a lodging to be rented (i.e., a lodging the client 120-1 wants to rent). In an example, the client 120-2 may indicate lodgings in Seoul, Korea and New York, U.S.A. as lodgings to be rented in first and second travel areas, respectively in an accommodation request the client 120-2 transmits to the web server 100. The communication unit 227 may be implemented by hardware and software/firmware for performing communications, e.g., internet protocol (IP) based communications with the clients 120 through the communication network 150. In an example, the communication unit 227 may be implemented by a communication interface that complies with the TCP/IP communication protocol.

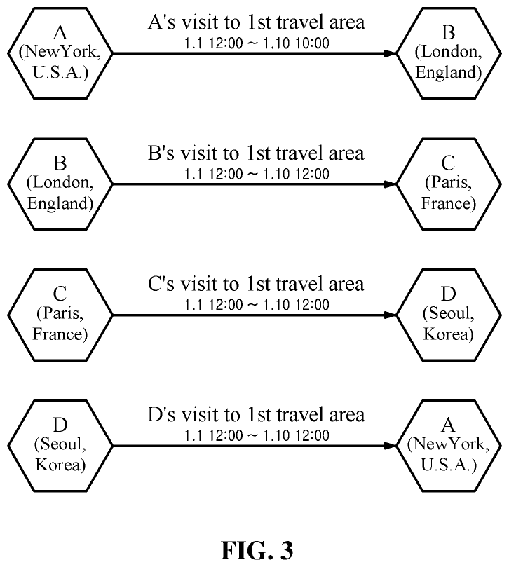

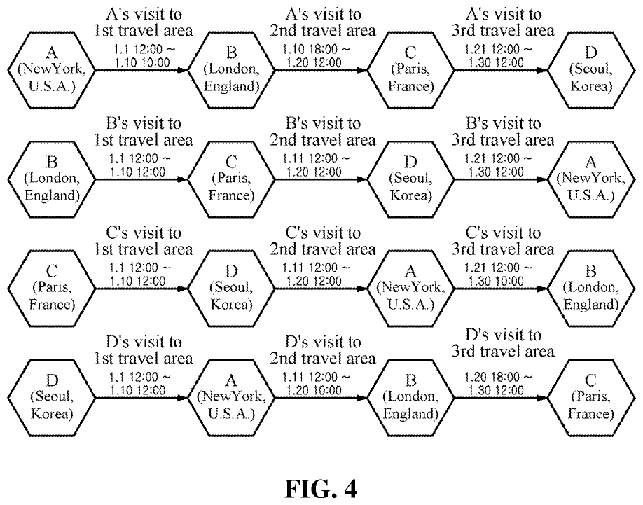

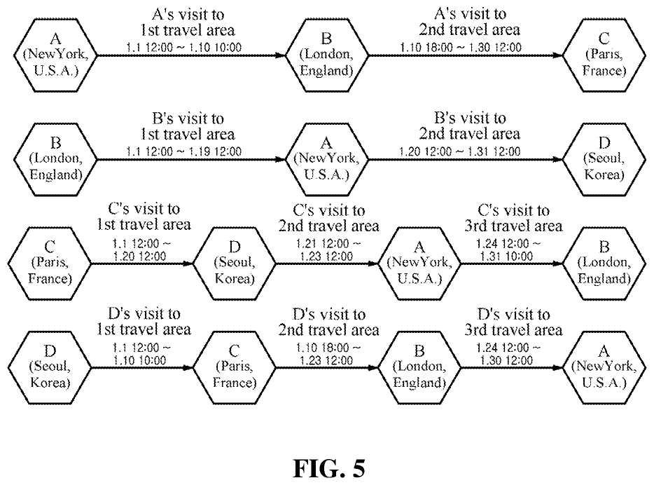

The host system 220 may further comprise a control unit 225 operatively coupled to the database 210 and configured to form an accommodation sharing candidate group based on the accommodation requests. The accommodation sharing candidate group may be identified by a group identification (ID), and the group ID may be associated with a plurality of member identifications (IDs). The plurality of member IDs may identify some of the plurality of clients 120 that belong to the formed accommodation sharing candidate group. The formed accommodation sharing candidate group may comprise only a one hop lodging candidate group, and may further comprise a two hop lodging candidate group, a three hop lodging candidate group, etc. As shown in FIG. 3, a case in which only a one hop lodging candidate group is formed can be exemplified by a closed loop sharing scheme. According to the closed loop sharing scheme, if it is assumed that there are four members involved in the sharing, member A uses a lodging owned by member B, member B uses a lodging owned by member C, member C uses a lodging owned by member D, and member D uses a lodging owned by member A. Specifically, member A who resides in New York, U.S.A. uses a lodging owned by member B who resides in London, England during the period from January 1, 12:00 to January 10, 10:00; member B who resides in London, England in turn uses a lodging owned by member C who resides in Paris, France during the same period; member C who resides in Paris, France in turn uses a lodging owned by member D who resides in Seoul, Korea during the same period; and member D who resides in Seoul, Korea in turn uses a lodging owned by member A who resides in New York, U.S.A. during the same period. As shown in FIG. 4, a case in which a one hop lodging candidate group to a three hop lodging candidate group are formed for all the members can be exemplified by the scenario where member A uses the lodgings owned by members B, C and D respectively in the first to third travel areas; member B uses the lodgings owned by members C, D and A respectively in the first to third travel areas; member C uses the lodgings owned by members D, A and B respectively in the first to third travel areas; and member D uses the lodgings owned by members A, B and C respectively in the first to third travel areas. In addition, there may be a case in which a one hop lodging candidate group and a two hop lodging candidate group are formed for some of the members and a one hop lodging candidate group to a three hop lodging candidate group are formed for the remaining members. This case is illustrated in FIG. 5. Referring to FIG. 5, member A uses the lodging owned by member B during the period from January 1, 12:00 to January 10, 10:00 and uses the lodging owned by member C during the period from January 10, 18:00 to January 30, 12:00, so that member A is included in the one hop lodging candidate group and the two hop lodging candidate group. Member B uses the lodging owned by member A during the period from January 1, 12:00 to January 19, 12:00 and uses the lodging owned by member D during the period from January 20, 12:00 to January 31, 12:00, so that member B is included in the one hop lodging candidate group and the two hop lodging candidate group. Member C uses the lodging owned by member D during the period from January 1, 12:00 to January 20, 12:00, uses the lodging owned by member A during the period from January 21, 12:00 to January 23, 12:00, and uses the lodging owned by member B during the period from January 24, 12:00 to January 31, 10:00, so that member C is included in the one hop lodging candidate group to the three hop lodging candidate group. Member D uses the lodging owned by member C during the period from January 1, 12:00 to January 10, 10:00, uses the lodging owned by member B during the period from January 10, 18:00 to January 23, 12:00, and uses the lodging owned by member A during the period from January 24, 12:00 to January 30, 12:00, so that member D is included in the one hop lodging candidate group to the three hop lodging candidate group. While the examples of forming an accommodation sharing candidate group as a one hop lodging candidate group of the closed loop pattern or as a multi hop lodging candidate group of the closed loop or mixed pattern have been explained in the above, it should be appreciated that examples of forming an accommodation sharing candidate group in various other ways are possible and all such examples fall within the scope of the disclosed technology.

The control unit 225 may be configured to perform an arbitration function to resolve conflicts among the plurality of members as to closing date and time penalty charges for the lodgings offered for rental, opening date and time penalty charges for the lodgings offered for rental, closing date and time penalty charges for the lodgings to be rented, opening date and time penalty charges for the lodgings to be rented, arrangement/equipment defect penalty charges for the lodgings offered for rental, arrangement/equipment defect penalty charges for the lodgings to be rented, opening date and times for the lodgings offered for rental, closing date and times for the lodgings offered for rental, opening date and times for the lodgings to be rented, and/or closing date and times for the lodgings to be rented. For example, the control unit 225 may receive, through the communication unit 227 from each of the clients respectively identified by the plurality of member IDs, a message including information on a closing date and time penalty charge for the lodging offered for rental by the respective client, and forward the received information on the closing date and time penalty charge to one of the clients identified by a member ID of a member who will use the corresponding lodging offered for rental so that arbitration can be made as to the closing date and time penalty charge between the two clients. The control unit 225 may receive, through the communication unit 227 from each of the clients respectively identified by the plurality of member IDs, a message including information on an opening date and time penalty charge for the lodging offered for rental by the respective client, and forward the received information on the opening date and time penalty charge to one of the clients identified by a member ID of a member who will use the corresponding lodging offered for rental so that arbitration can be made as to the opening date and time penalty charge between the two clients. The control unit 225 may receive, through the communication unit 227 from each of the clients respectively identified by the plurality of member IDs, a message including information on an arrangement/equipment defect penalty charge for the lodging offered for rental by the respective client, and forward the received information on the arrangement/equipment defect penalty charge to one of the clients identified by a member ID of a member who will use the corresponding lodging offered for rental so that arbitration can be made as to the arrangement/equipment defect penalty charge between the two clients. The control unit 225 may provide, through the communication unit 227 to each of the two or more clients respectively identified by the plurality of member IDs, information on a lodging fee for at least one nearby lodging facility located within a predetermined distance from the lodging offered for rental by the respective client in order to assist the respective client in estimating the closing date and time penalty charge, the opening date and time penalty charge and/or the arrangement/equipment defect penalty charge.

Once the conflicts among the plurality of members as to the closing date and time penalty charges for the lodgings offered for rental, the opening date and time penalty charges for the lodgings offered for rental, the closing date and time penalty charges for the lodgings to be rented, the opening date and time penalty charges for the lodgings to be rented, the arrangement/equipment defect penalty charges for the lodgings offered for rental, the arrangement/equipment defect penalty charges for the lodgings to be rented, the opening date and times for the lodgings offered for rental, the closing date and times for the lodgings offered for rental, the opening date and times for the lodgings to be rented, and/or the closing date and times for the lodgings to be rented are resolved by performing the arbitration function, the control unit 225 may form an accommodation sharing candidate group by storing member information associated with each of the plurality of member IDs in the database 210. In this case, the control unit 225 may form member information associated with each of the plurality of member IDs by using lodging related information for the respective member ID pre-stored in the database 210, information obtained by updating the above lodging related information and/or newly generated information in the process of forming the accommodation sharing candidate group. In the disclosure provided herein, storing member information in the database may encompass the meaning of newly storing the member information as well as the meaning of creating a data structure such as a relational data table using pre-stored or partially pre-stored information solely or in combination with newly generated information. The member information associated with each of the plurality of member IDs may include information on the opening date and time for the lodging offered for rental by one of the clients identified by the respective member ID, the closing date and time for the corresponding lodging offered for rental, the opening date and time for the lodging to be rented by the client, the closing date and time for the corresponding lodging to be rented, the opening date and time penalty charge for the corresponding lodging offered for rental, the closing date and time penalty charge for the corresponding lodging offered for rental, the opening date and time penalty charge for the corresponding lodging to be rented, and the closing date and time penalty charge for the corresponding lodging to be rented. The member information associated with each of the plurality of member IDs may further include information on a bank account associated with the respective member ID. The lodging to be rented may be a lodging offered by one of the clients identified by any one member ID of the plurality of member IDs. The member information associated with each of the plurality of member IDs may further include information on the arrangement/equipment defect penalty charge for the lodging offered for rental by one of the clients identified by the respective member ID and information on the arrangement/equipment defect penalty charge for the lodging to be rented by the client.

The control unit 225 may be further configured to transmit, through the communication unit 227 to one of the clients identified by each of the plurality of member IDs, a guidance message for requesting to deposit the opening date and time penalty charge for the lodging offered for rental by the client and the closing date and time penalty charge for the lodging to be rented by the client to a bank account designated by the administrator. In an example, the guidance message may include an approval request message for requesting approval of a wire transfer of the opening date and time penalty charge for the corresponding lodging offered for rental and the closing date and time penalty charge for the corresponding lodging to be rented from the bank account associated with the corresponding member ID to the bank account designated by the administrator. The control unit 225 may be further configured to confirm online that for each of the plurality of member IDs, the closing date and time penalty charge for the lodging offered for rental by one of the clients identified by the respective member ID and the opening date and time penalty charge for the lodging to be rented by the client are deposited to the bank account designated by the administrator. In an example, the control unit 225 may be operatively coupled to a General Saving Management Device (not shown) and may confirm online via the General Saving Management Device that the above penalty charges are deposited to the bank account designated by the administrator. The control unit 225 may be further configured to set the accommodation sharing candidate group as an accommodation sharing group in response to confirming online that for each of the plurality of member IDs, the above penalty charges are deposited to the bank account designated by the administrator. In an example, a group ID for the accommodation sharing group may be identical to the group ID for the accommodation sharing candidate group. In an example, a group ID for the accommodation sharing group may be different from the group ID for the accommodation sharing candidate group.

The control unit 225 may be further configured to transmit, through the communication unit 227 to one of the clients identified by each of the plurality of member IDs, a guidance message for requesting to deposit the arrangement/equipment defect penalty charge for the lodging offered for rental by the client to the bank account designated by the administrator. In an example, the guidance message may include an approval request message for requesting approval of a wire transfer of the arrangement/equipment defect penalty charge for the corresponding lodging offered for rental from the bank account associated with the corresponding member ID to the bank account designated by the administrator. The control unit 225 may be further configured to confirm online, e.g., via the General Saving Management Device that for each of the plurality of member IDs, the arrangement/equipment defect penalty charge for the lodging to be rented by one of the clients identified by the respective member ID is deposited to the bank account designated by the administrator, and in response thereto, set the accommodation sharing candidate group as an accommodation sharing group. In an example, a group ID for the accommodation sharing group may be identical to the group ID for the accommodation sharing candidate group. In an example, a group ID for the accommodation sharing group may be different from the group ID for the accommodation sharing candidate group.

The control unit 225 may be further configured to operate in such a manner that when a certain condition is met, a command message commanding to visit the lodging offered for rental by one of the clients identified by a particular member ID associated with the group ID of the accommodation sharing group is transmitted through the communication unit 227 to the administrator terminal 130. The certain condition is met if an alarm message is not received through the communication unit 227 from the client identified by the particular member ID within a predetermined period of time from the closing date and time for the corresponding lodging offered for rental (i.e., the lodging offered by the client). The alarm message may be a message notifying that the corresponding lodging offered for rental is closed. In an example, the predetermined period of time may be set to an arbitrary time period of from 0 hour to 24 hours. The control unit 225 may be further configured to control the closing date and time penalty charge for the lodging offered for rental by the client identified by the particular member ID to be deposited online, e.g., via the General Saving Management Device to the bank account associated with the particular member ID in response to receiving a message including identification information identifying the particular member ID through the communication unit 227 from the administrator terminal 130. The particular member ID may be a member ID identifying the client offering the corresponding lodging offered for rental, i.e., an owner of the corresponding lodging offered for rental or a member ID identifying the second client, the third client, etc. who use the same lodging offered for rental. The identification information identifying the particular member ID may be any one selected from the group consisting of a password identifying the particular member ID, fingerprint information identifying the particular member ID, blood vessel information identifying the particular member ID, iris information identifying the particular member ID, retina information identifying the particular member ID, voice information identifying the particular member ID, image information identifying the particular member ID, signature information identifying the particular member ID, text information identifying the particular member ID, sound information identifying the particular member ID, and encryption information obtained by encrypting the password identifying the particular member ID, the fingerprint information identifying the particular member ID, the blood vessel information identifying the particular member ID, the iris information identifying the particular member ID, the retina information identifying the particular member ID, the voice information identifying the particular member ID, the image information identifying the particular member ID, the signature information identifying the particular member ID, the text information identifying the particular member ID or the sound information identifying the particular member ID. In an example, the control unit 225 may be further configured to control the closing date and time penalty charge for the lodging offered for rental by one of the clients identified by the particular member ID to be deposited online to the bank account associated with the particular member ID in response to receiving a message including administrator identification information through the communication unit 227 from the client identified by the particular member ID. In an example, the administrator identification information may be identification information known only to employees under the control of the administrator (management) who are carrying the administrator terminal 130, information identifying such employees or information given to employees carrying the administrator terminal 130 by the administrator or the web server 100. In an example, the control unit 225 may be further configured to operate in such a manner that when certain conditions are met, the closing date and time penalty charge for the lodging offered for rental by one of the clients identified by a particular member ID associated with the group ID of the accommodation sharing group is deposited online to the bank account associated with the particular member ID. In such an example, the certain conditions are met if the alarm message is not received through the communication unit 227 from the client identified by the particular member ID within a predetermined period of time from the closing date and time for the corresponding lodging offered for rental, and if a message including identification information identifying the particular member ID is received through the communication unit 227 from the administrator terminal 130 or a message including administrator identification information is received through the communication unit 227 from the client identified by the particular member ID.

The control unit 225 may be further configured to operate in such a manner that when a certain condition is met, a command message commanding to visit the lodging to be rented by one of the clients identified by a particular member ID is transmitted through the communication unit 227 to the administrator terminal 130. The certain condition is met if an alarm message is not received through the communication unit 227 from the client identified by the particular member ID within a predetermined period of time from the opening date and time for the corresponding lodging to be rented. The alarm message may be a message notifying that the corresponding lodging to be rented is opened from the opening date and time for the corresponding lodging to be rented. In an example, the predetermined period of time may be set to an arbitrary time period of from 0 hour to 24 hours. The control unit 225 may be further configured to control the opening date and time penalty charge for the lodging to be rented by the client identified by the particular member ID to be deposited online, e.g., via the General Saving Management Device to the bank account associated with the particular member ID in response to receiving a message including identification information identifying the particular member ID through the communication unit 227 from the administrator terminal 130. The particular member ID may be a member ID identifying the first client, the second client, the third client, etc. who use the same lodging to be rented. The identification information identifying the particular member ID may be any one selected from the group consisting of a password identifying the particular member ID, fingerprint information identifying the particular member ID, blood vessel information identifying the particular member ID, iris information identifying the particular member ID, retina information identifying the particular member ID, voice information identifying the particular member ID, image information identifying the particular member ID, signature information identifying the particular member ID, text information identifying the particular member ID, sound information identifying the particular member ID, and encryption information obtained by encrypting the password identifying the particular member ID, the fingerprint information identifying the particular member ID, the blood vessel information identifying the particular member ID, the iris information identifying the particular member ID, the retina information identifying the particular member ID, the voice information identifying the particular member ID, the image information identifying the particular member ID, the signature information identifying the particular member ID, the text information identifying the particular member ID or the sound information identifying the particular member ID. In an example, the control unit 225 may be further configured to control the opening date and time penalty charge for the lodging to be rented by one of the clients identified by the particular member ID to be deposited online to the bank account associated with the particular member ID in response to receiving a message including administrator identification information through the communication unit 227 from the client identified by the particular member ID. In an example, the administrator identification information may be identification information known only to employees under the control of the administrator (management) who are carrying the administrator terminal 130, information identifying such employees or information given to employees carrying the administrator terminal 130 by the administrator or the web server 100. In an example, the control unit 225 may be further configured to operate in such a manner that when certain conditions are met, the opening date and time penalty charge for the lodging to be rented by one of the clients identified by a particular member ID associated with the group ID of the accommodation sharing group is deposited online to the bank account associated with the particular member ID. In such an example, the certain conditions are met if the alarm message is not received through the communication unit 227 from the client identified by the particular member ID within a predetermined period of time from the opening date and time for the corresponding lodging to be rented, and if a message including identification information identifying the particular member ID is received through the communication unit 227 from the administrator terminal 130 or a message including administrator identification information is received through the communication unit 227 from the client identified by the particular member ID. As described above, the alarm message may be a message notifying that the corresponding lodging to be rented is opened.

The control unit 225 may be further configured to operate in such a manner that if an alarm message is received through the communication unit 227 from one of the clients identified by a particular member ID associated with the group ID of the accommodation sharing group, a command message commanding to visit the lodging to be rented by the client is transmitted through the communication unit 227 to the administrator terminal 130 at a predetermined period of time after receiving the alarm message. The alarm message may be a message notifying that a defect is present in an arrangement or equipment of the corresponding lodging to be rented. In an example, the predetermined period of time may be set to an arbitrary time period of from 0 hour to 24 hours. The control unit 225 may be further configured to control the arrangement/equipment defect penalty charge for the lodging to be rented by the client identified by the particular member ID to be deposited online, e.g., via the General Saving Management Device to the bank account associated with the particular member ID in response to receiving a message including identification information identifying the particular member ID through the communication unit 227 from the administrator terminal 130. The particular member ID may be a member ID identifying the first client, the second client, the third client, etc. who use the same lodging to be rented. The identification information identifying the particular member ID may be any one selected from the group consisting of a password identifying the particular member ID, fingerprint information identifying the particular member ID, blood vessel information identifying the particular member ID, iris information identifying the particular member ID, retina information identifying the particular member ID, voice information identifying the particular member ID, image information identifying the particular member ID, signature information identifying the particular member ID, text information identifying the particular member ID, sound information identifying the particular member ID, and encryption information obtained by encrypting the password identifying the particular member ID, the fingerprint information identifying the particular member ID, the blood vessel information identifying the particular member ID, the iris information identifying the particular member ID, the retina information identifying the particular member ID, the voice information identifying the particular member ID, the image information identifying the particular member ID, the signature information identifying the particular member ID, the text information identifying the particular member ID or the sound information identifying the particular member ID. In an example, the control unit 225 may be further configured to control the arrangement/equipment defect penalty charge for the lodging to be rented by one of the clients identified by the particular member ID to be deposited online to the bank account associated with the particular member ID in response to receiving a message including administrator identification information through the communication unit 227 from the client identified by the particular member ID. In an example, the administrator identification information may be identification information known only to employees under the control of the administrator (management) who are carrying the administrator terminal 130, information identifying such employees or information given to employees carrying the administrator terminal 130 by the administrator or the web server 100. In an example, the control unit 225 may be further configured to operate in such a manner that when certain conditions are met, the arrangement/equipment defect penalty charge for the lodging to be rented by one of the clients identified by a particular member ID associated with the group ID of the accommodation sharing group is deposited online to the bank account associated with the particular member ID. In such an example, the certain conditions are met if the alarm message is received through the communication unit 227 from the client identified by the particular member ID, and if a message including identification information identifying the particular member ID is received through the communication unit 227 from the administrator terminal or a message including administrator identification information is received through the communication unit 227 from the client identified by the particular member ID. As described above, the alarm message may be a message notifying that a defect is present in an arrangement or equipment of the corresponding lodging to be rented.

Examples of the control unit 225 as described above may be implemented, in terms of hardware, by using at least one among application specific integrated circuits (ASICs), digital signal processors (DSPs), digital signal processing devices (DSPDs), programmable logic devices (PLDs), field-programmable gate arrays (FPGAs), processors, controllers, micro-controllers, and microprocessors. Examples of the web server 100 involving procedures, operations or functions may be implemented with a firmware/software module that performs at least one function or operation and is executable on the above-described hardware platform. The firmware/software module may be implemented by one or more software applications written in a suitable program language.

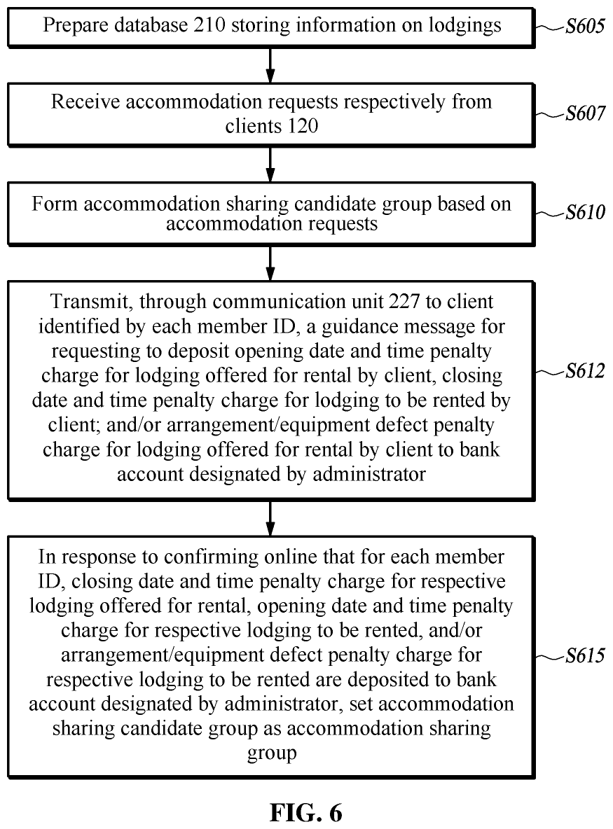

FIG. 6 is a view illustrating an example of a flowchart for explaining a process of setting an accommodation sharing group in implementing a method of providing a web platform based accommodation sharing service according to an example of the disclosed technology.

The process begins at operation S605 where the database 210 storing information on a plurality of lodgings is prepared. As described above, if each of the clients 120 uploads information on a lodging offered for rental by himself to the web server 100 through web pages, windows, etc. provided by the web server 100, such information may be collected and stored in the database 210 as information on the plurality of lodgings. At operation S607, accommodation requests are received respectively from the plurality of clients 120. Each of the accommodation requests may include information indicating at least one of the plurality of lodgings. At operation S610, an accommodation sharing candidate group is formed based on the accommodation requests. The accommodation sharing candidate group may be identified by a group ID, and the group ID may be associated with a plurality of member IDs. The plurality of member IDs may identify two or more of the plurality of clients 120 that belong to the formed accommodation sharing candidate group. At this operation, an arbitration process may be performed to arbitrate conflicts among the plurality of members as to closing date and time penalty charges for the lodgings offered for rental, opening date and time penalty charges for the lodgings offered for rental, closing date and time penalty charges for the lodgings to be rented, opening date and time penalty charges for the lodgings to be rented, arrangement/equipment defect penalty charges for the lodgings offered for rental, arrangement/equipment defect penalty charges for the lodgings to be rented, opening date and times for the lodgings offered for rental, closing date and times for the lodgings offered for rental, opening date and times for the lodgings to be rented, and/or closing date and times for the lodgings to be rented. Once the conflicts among the plurality of members are resolved by performing the arbitration process, the accommodation sharing candidate group may be formed by storing member information associated with each of the plurality of member IDs in the database 210. As described above, the member information associated with each of the plurality of member IDs may include information on the opening date and time for the lodging offered for rental by one of the clients identified by the respective member ID, the closing date and time for the corresponding lodging offered for rental, the opening date and time for the lodging to be rented by the client, the closing date and time for the corresponding lodging to be rented, the opening date and time penalty charge for the corresponding lodging offered for rental, the closing date and time penalty charge for the corresponding lodging offered for rental, the opening date and time penalty charge for the corresponding lodging to be rented, the closing date and time penalty charge for the corresponding lodging to be rented, the arrangement/equipment defect penalty charge for the corresponding lodging offered for rental, and the arrangement/equipment defect penalty charge for the corresponding lodging to be rented. The member information associated with each of the plurality of member IDs may further include information on a bank account associated with the respective member ID.

At operation S612, a guidance message is transmitted through the communication unit 227 to one of the clients identified by each of the plurality of member IDs. The guidance message is purported to request to deposit the opening date and time penalty charge for the lodging offered for rental by the client, the closing date and time penalty charge for the lodging to be rented by the client, and/or the arrangement/equipment defect penalty charge for the corresponding lodging offered for rental to a bank account designated by the administrator. At operation S615, in response to confirming online that for each of the plurality of member IDs, the closing date and time penalty charge for the lodging offered for rental by the client identified by the respective member ID, the opening date and time penalty charge for the lodging to be rented by the client, and/or the arrangement/equipment defect penalty charge for the corresponding lodging to be rented are deposited to the bank account designated by the administrator, the accommodation sharing candidate group is set as an accommodation sharing group.

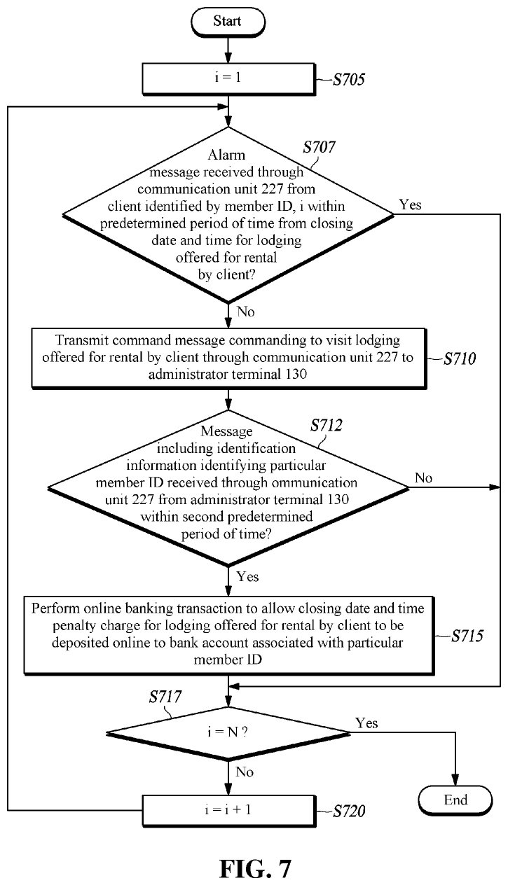

FIG. 7 is a view illustrating an example of a flowchart for explaining a process of paying a closing date and time penalty charge for a lodging offered for rental, which is executed when the lodging offered for rental is not closed at a preset closing date and time, in implementing a method of providing a web platform based accommodation sharing service according to an example of the disclosed technology.

The process begins at operation S705 where index i for a member ID associated with the group ID of the accommodation sharing group is set to 1 (it is assumed that a total number of the member IDs associated with the group ID of the accommodation sharing group is N, where N is a natural number). At operation S707, it is checked whether an alarm message is received through the communication unit 227 from one of the clients identified by the member ID, i within a predetermined period of time from the closing date and time for the lodging offered for rental by the client. The alarm message may be a message notifying that the corresponding lodging offered for rental is closed. If it is determined that the alarm message is received through the communication unit 227 from the client identified by the member ID, i within the predetermined period of time from the closing date and time for the lodging offered for rental by the client, the process proceeds to operation S717. On the other hand, if it is determined that the alarm message is not received through the communication unit 227 from the client identified by the member ID, i within the predetermined period of time from the closing date and time for the lodging offered for rental, a command message commanding to visit the corresponding lodging offered for rental is transmitted through the communication unit 227 to the administrator terminal 130 (operation S710). At operation S712, it is checked whether a message including identification information identifying a particular member ID is received through the communication unit 227 from the administrator terminal 130 within a second predetermined period of time. If it is determined that the message including identification information identifying the particular member ID is not received through the communication unit 227 from the administrator terminal 130 within the second predetermined period of time, the process proceeds to operation S717. On the other hand, if it is determined that the message including identification information identifying the particular member ID is received through the communication unit 227 from the administrator terminal 130 within the second predetermined period of time, at operation S715, an online banking transaction is effected to allow the closing date and time penalty charge for the lodging offered for rental by the client identified by the particular member ID to be deposited online, e.g., via the General Saving Management Device to the bank account associated with the particular member ID. At operation S717, it is checked whether index i for the member ID is N. If it is determined that index i for the member ID is N, the process then terminates. On the other hand, if it is determined that index i for the member ID is not N, at operation S720, index i is incremented by 1 and the process returns to operation S707.

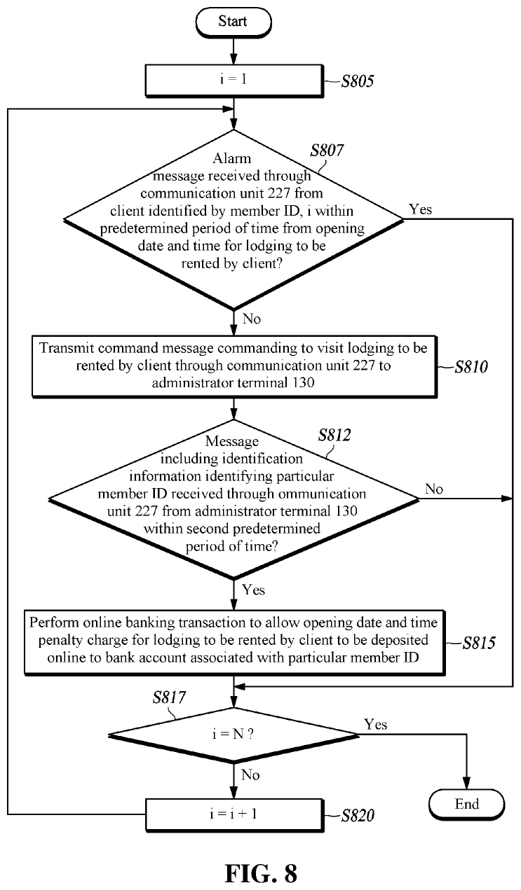

FIG. 8 is a view illustrating an example of a flowchart for explaining a process of paying an opening date and time penalty charge for a lodging to be rented, which is executed when the lodging to be rented is not opened at a preset opening date and time, in implementing a method of providing a web platform based accommodation sharing service according to an example of the disclosed technology.

The process begins at operation S805 where index i for a member ID associated with the group ID of the accommodation sharing group is set to 1. At operation S807, it is checked whether an alarm message is received through the communication unit 227 from one of the clients identified by the member ID, i within a predetermined period of time from the opening date and time for the lodging to be rented by the client. The alarm message may be a message notifying that the corresponding lodging to be rented is opened. If it is determined that the alarm message is received through the communication unit 227 from the client identified by the member ID, i within the predetermined period of time from the opening date and time for the corresponding lodging to be rented, the process proceeds to operation S817. On the other hand, if it is determined that the alarm message is not received through the communication unit 227 from the client identified by the member ID, i within the predetermined period of time from the opening date and time for the corresponding lodging to be rented, a command message commanding to visit the corresponding lodging to be rented is transmitted through the communication unit 227 to the administrator terminal 130 (operation S810). At operation S812, it is checked whether a message including identification information identifying a particular member ID is received through the communication unit 227 from the administrator terminal 130 within a second predetermined period of time. If it is determined that the message including identification information identifying the particular member ID is not received through the communication unit 227 from the administrator terminal 130 within the second predetermined period of time, the process proceeds to operation S817. On the other hand, if it is determined that the message including identification information identifying the particular member ID is received through the communication unit 227 from the administrator terminal 130 within the second predetermined period of time, at operation S815, an online banking transaction is effected to allow the opening date and time penalty charge for the lodging to be rented by the client identified by the particular member ID to be deposited online, e.g., via the General Saving Management Device to the bank account associated with the particular member ID. At operation S817, it is checked whether index i for the member ID is N. If it is determined that index i for the member ID is N, the process then terminates. On the other hand, if it is determined that index i for the member ID is not N, at operation S820, index i is incremented by 1 and the process returns to operation S807.

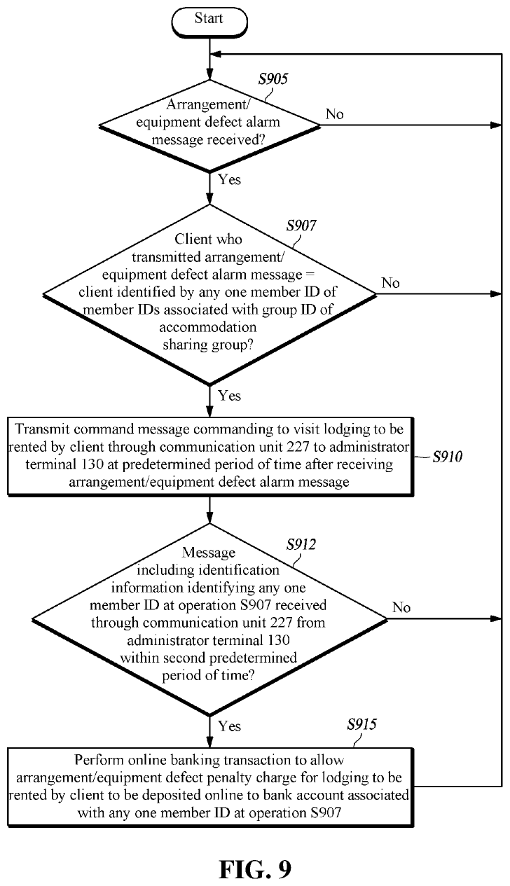

FIG. 9 is a view illustrating an example of a flowchart for explaining a process of paying an arrangement/equipment defect penalty charge for a lodging to be rented, which is executed when a defect is present in an arrangement or equipment of the lodging to be rented, in implementing a method of providing a web platform based accommodation sharing service according to an example of the disclosed technology.

The process begins at operation S905 where it is checked whether an arrangement/equipment defect alarm message is received. If it is determined that the arrangement/equipment defect alarm message is not received, the process returns to operation S905. On the other hand, if it is determined that the arrangement/equipment defect alarm message is received, at operation S907, it is checked whether the client who transmitted the arrangement/equipment defect alarm message is a client identified by any one member ID of the member IDs associated with the group ID of the accommodation sharing group. If it is determined that the client who transmitted the arrangement/equipment defect alarm message is not a client identified by any one member ID of the member IDs associated with the group ID of the accommodation sharing group, the process returns to operation S905. On the other hand, if it is determined that the client who transmitted the arrangement/equipment defect alarm message is a client identified by any one member ID of the member IDs associated with the group ID of the accommodation sharing group, a command message commanding to visit the lodging to be rented by the client (i.e., the lodging the client is using or purports to use) is transmitted through the communication unit 227 to the administrator terminal 130 at a predetermined period of time after receiving the arrangement/equipment defect alarm message (operation S910). At operation S912, it is checked whether a message including identification information identifying the above member ID, which in turn identifies the client, is received through the communication unit 227 from the administrator terminal 130 within a second predetermined period of time. If it is determined that the message including identification information identifying the above member ID is not received through the communication unit 227 from the administrator terminal 130 within the second predetermined period of time, the process returns to operation S905. On the other hand, if it is determined that the message including identification information identifying the above member ID is received through the communication unit 227 from the administrator terminal 130 within the second predetermined period of time, at operation S915, an online banking transaction is effected to allow the arrangement/equipment defect penalty charge for the lodging to be rented by the client to be deposited online, e.g., via the General Saving Management Device to the bank account associated with the above member ID, and the process returns to operation S905.

According to the examples of the disclosed technology as described above, lodgings can be shared among travelers to alleviate the travelers' burden of paying costly lodging expenses. Even if traveler A wants to use traveler B's house, traveler B may want to use a third party's house. In this case, there occurs a problem that the travelers' preferences do not match each other, with the result being that traveler A cannot use traveler B's house, i.e., accommodation sharing between travelers A and B is made impossible. Even if the problem is partially solved, i.e., an environment where two people living on the opposite sides of the earth use each other's house is created to a certain degree, the two people most likely do not even know each other in almost all cases, and thus it is difficult for either party to head towards a place where the other party's house is located, relying unilaterally on the other party's promise and at the expense of a lot of expenses (airline fares, etc.), time, opportunities. Further, even if a considerable degree of confidence in terms of sharing accommodation is formed between two people and thus the two people are willing to head towards each other's house, the possibility that one of the two people who promised to provide his house does not provide the house intentionally at the promised date and time or cannot provide the house for unavoidable reasons cannot be completely ruled out. Thus, a person, who traveled thousands of miles or tens of thousands of miles from a foreign country, relying unilaterally on a promise by an owner of a house to provide his house and at the expense of a lot of expenses (airline fares, etc.), time, opportunities, should inevitably take the risk of being placed in a situation where he cannot be provided with the house by the owner of the house. In this case, the above person who attempted to use the house should first suffer damage, and an international lawsuit should be filed to be compensated for the damage. However, since every country has different laws/regulations and different manner of applying the same, filing an international lawsuit cannot be a realistic solution. The examples of the disclosed technology solve the above-described situations and provide means for making accommodation sharing among travelers realistic.

In the examples disclosed herein, the arrangement of the illustrated components may vary depending on an environment or requirements to be implemented. For example, some of the components may be omitted or several components may be integrated and carried out together. In addition, the arrangement order and connection of some of the components and the like may be changed.

While various examples of the disclosed technology have been shown and explained in the above, the disclosed technology is not to be limited to the specific examples set forth here. Various changes in form and details may be made in these examples by those skilled in the art without departing from the spirit and scope of the appended claims. These changed examples are not to be understood as being separate from the spirit and scope of the disclose technology. Thus, the scope of the disclosed technology is only to be defined by the appended claims.

1.-55. (canceled)

56. A method of providing a web platform based accommodation sharing service, comprising:
preparing a database storing information on a plurality of lodgings;
receiving accommodation requests respectively from a plurality of clients, each of the accommodation requests including information indicating at least one of the plurality of lodgings; and
forming an accommodation sharing candidate group based on the accommodation requests, said accommodation sharing candidate group being identified by a group identification (ID), said group ID being associated with a plurality of member identifications (IDs), and said plurality of member IDs identifying two or more of the plurality of clients,
wherein the forming an accommodation sharing candidate group comprises storing member information associated with each of the plurality of member IDs, said member information associated with each of the plurality of member IDs including information on an opening date and time for a lodging offered for rental, a closing date and time for the lodging offered for rental, an opening date and time for a lodging to be rented, a closing date and time for the lodging to be rented, an opening date and time penalty charge for the lodging offered for rental, a closing date and time penalty charge for the lodging offered for rental, an opening date and time penalty charge for the lodging to be rented, and a closing date and time penalty charge for the lodging to be rented, and said member information associated with each of the plurality of member IDs further including information on a bank account associated with the respective member ID,
said method further comprising:
setting the accommodation sharing candidate group as an accommodation sharing group in response to confirming online that for each of the plurality of member IDs, the closing date and time penalty charge for the respective lodging offered for rental and the opening date and time penalty charge for the respective lodging to be rented are deposited to a bank account designated by an administrator; and
if an alarm message is not received from a client identified by a particular member ID associated with the group ID of the accommodation sharing group within a predetermined period of time from the closing date and time for the respective lodging offered for rental, said alarm message notifying that the respective lodging offered for rental is closed, and if a message including identification information identifying the particular member ID is received from an administrator terminal or a message including administrator identification information is received from the client identified by the particular member ID, controlling the closing date and time penalty charge for the respective lodging offered for rental to be deposited online to the bank account associated with the particular member ID.

57. The method of claim 56, wherein the controlling the closing date and time penalty charge for the respective lodging offered for rental to be deposited online to the bank account associated with the particular member ID comprises transmitting, to the administrator terminal, a command message commanding to visit the respective lodging offered for rental if the alarm message is not received from the client identified by the particular member ID associated with the group ID of the accommodation sharing group within the predetermined period of time from the closing date and time for the respective lodging offered for rental.

58. The method of claim 56, wherein the lodging to be rented is a lodging offered by a client identified by any one member ID of the plurality of member IDs, and the information on the plurality of lodgings comprises information on the lodging offered for rental and information on the lodging to be rented.

59. The method of claim 56, further comprising: transmitting, to a client identified by each of the plurality of member IDs, a guidance message for requesting to deposit the opening date and time penalty charge for the respective lodging offered for rental and the closing date and time penalty charge for the respective lodging to be rented to the bank account designated by the administrator.

60. The method of claim 56, further comprising: if an alarm message is not received from the client identified by the particular member ID within a predetermined period of time from the opening date and time for the respective lodging to be rented, said alarm message notifying that the respective lodging to be rented is opened from the opening date and time for the respective lodging to be rented, and if a message including the identification information identifying the particular member ID is received from the administrator terminal or a message including the administrator identification information is received from the client identified by the particular member ID, controlling the opening date and time penalty charge for the respective lodging to be rented to be deposited online to the bank account associated with the particular member ID.

61. The method of claim 56, wherein the forming an accommodation sharing candidate group based on the accommodation requests comprises receiving, from at least one of the two or more clients respectively identified by the plurality of member IDs, information on the closing date and time penalty charge for the respective lodging offered for rental.

62. The method of claim 61, wherein the forming an accommodation sharing candidate group based on the accommodation requests comprises receiving, from at least one of the two or more clients respectively identified by the plurality of member IDs, information on the opening date and time penalty charge for the respective lodging offered for rental.

63. The method of claim 61, wherein the receiving, from each of the two or more clients respectively identified by the plurality of member IDs, information on the closing date and time penalty charge for the respective lodging offered for rental comprises providing, to each of the two or more clients respectively identified by the plurality of member IDs, information on a lodging fee for at least one nearby lodging facility located within a predetermined distance from the respective lodging offered for rental.

64. The method of claim 62, wherein the receiving, from each of the two or more clients respectively identified by the plurality of member IDs, information on the opening date and time penalty charge for the respective lodging offered for rental comprises providing, to each of the two or more clients respectively identified by the plurality of member IDs, information on a lodging fee for at least one nearby lodging facility located within a predetermined distance from the respective lodging offered for rental.

65. The method of claim 56, wherein the identification information identifying the particular member ID is any one selected from the group consisting of a password identifying the particular member ID, fingerprint information identifying the particular member ID, blood vessel information identifying the particular member ID, iris information identifying the particular member ID, retina information identifying the particular member ID, voice information identifying the particular member ID, image information identifying the particular member ID, signature information identifying the particular member ID, text information identifying the particular member ID, sound information identifying the particular member ID, and encryption information obtained by encrypting the password identifying the particular member ID, the fingerprint information identifying the particular member ID, the blood vessel information identifying the particular member ID, the iris information identifying the particular member ID, the retina information identifying the particular member ID, the voice information identifying the particular member ID, the image information identifying the particular member ID, the signature information identifying the particular member ID, the text information identifying the particular member ID or the sound information identifying the particular member ID.

66. The method of claim 56, wherein the accommodation sharing candidate group is one of a one hop lodging candidate group for one hop accommodation sharing, a two hop lodging candidate group for two hop accommodation sharing, and a three hop lodging candidate group for three hop accommodation sharing.

67. A method of providing a web platform based accommodation sharing service, comprising:
preparing a database storing information on a plurality of lodgings;
receiving accommodation requests respectively from a plurality of clients, each of the accommodation requests including information indicating at least one of the plurality of lodgings; and
forming an accommodation sharing candidate group based on the accommodation requests, said accommodation sharing candidate group being identified by a group identification (ID), said group ID being associated with a plurality of member identifications (IDs), and said plurality of member IDs identifying two or more of the plurality of clients,
wherein the forming an accommodation sharing candidate group comprises storing member information associated with each of the plurality of member IDs, said member information associated with each of the plurality of member IDs including information on an opening date and time for a lodging offered for rental, a closing date and time for the lodging offered for rental, an opening date and time for a lodging to be rented, a closing date and time for the lodging to be rented, an opening date and time penalty charge for the lodging offered for rental, a closing date and time penalty charge for the lodging offered for rental, an opening date and time penalty charge for the lodging to be rented, and a closing date and time penalty charge for the lodging to be rented, and said member information associated with each of the plurality of member IDs further including information on a bank account associated with the respective member ID,
said method further comprising:
setting the accommodation sharing candidate group as an accommodation sharing group in response to confirming online that for each of the plurality of member IDs, the closing date and time penalty charge for the respective lodging offered for rental and the opening date and time penalty charge for the respective lodging to be rented are deposited to a bank account designated by an administrator; and
if an alarm message is not received from a client identified by a particular member ID associated with the group ID of the accommodation sharing group within a predetermined period of time from the opening date and time for the respective lodging to be rented, said alarm message notifying that the respective lodging to be rented is opened, and if a message including identification information identifying the particular member ID is received from an administrator terminal or a message including administrator identification information is received from the client identified by the particular member ID, controlling the opening date and time penalty charge for the respective lodging to be rented to be deposited online to the bank account associated with the particular member ID.

68. The method of claim 67, wherein the controlling the opening date and time penalty charge for the respective lodging to be rented to be deposited online to the bank account associated with the particular member ID comprises transmitting, to the administrator terminal, a command message commanding to visit the respective lodging to be rented if the alarm message is not received from the client identified by the particular member ID associated with the group ID of the accommodation sharing group within the predetermined period of time from the opening date and time for the respective lodging to be rented.

69. The method of claim 67, wherein the lodging to be rented is a lodging offered by a client identified by any one member ID of the plurality of member IDs, and the information on the plurality of lodgings comprises information on the lodging offered for rental and information on the lodging to be rented.

70. The method of claim 67, further comprising: transmitting, to a client identified by each of the plurality of member IDs, a guidance message for requesting to deposit the opening date and time penalty charge for the respective lodging offered for rental and the closing date and time penalty charge for the respective lodging to be rented to the bank account designated by the administrator.

71. The method of claim 67, further comprising: if an alarm message is not received from the client identified by the particular member ID within a predetermined period of time from the closing date and time for the respective lodging offered for rental, said alarm message notifying that the respective lodging offered for rental is closed from the closing date and time for the respective lodging offered for rental, and if a message including the identification information identifying the particular member ID is received from the administrator terminal or a message including the administrator identification information is received from the client identified by the particular member ID, controlling the closing date and time penalty charge for the respective lodging offered for rental to be deposited online to the bank account associated with the particular member ID.

71. The method of claim 67, wherein the forming an accommodation sharing candidate group based on the accommodation requests comprises receiving, from at least one of the two or more clients respectively identified by the plurality of member IDs, information on the closing date and time penalty charge for the respective lodging offered for rental.

72. The method of claim 67, wherein the forming an accommodation sharing candidate group based on the accommodation requests comprises receiving, from at least one of the two or more clients respectively identified by the plurality of member IDs, information on the opening date and time penalty charge for the respective lodging offered for rental.

73. The method of claim 67, wherein the receiving, from each of the two or more clients respectively identified by the plurality of member IDs, information on the closing date and time penalty charge for the respective lodging offered for rental comprises providing, to each of the two or more clients respectively identified by the plurality of member IDs, information on a lodging fee for at least one nearby lodging facility located within a predetermined distance from the respective lodging offered for rental.

74. A method of providing a web platform based accommodation sharing service, comprising:
preparing a database storing information on a plurality of lodgings;
receiving accommodation requests respectively from a plurality of clients, each of the accommodation requests including information indicating at least one of the plurality of lodgings; and
forming an accommodation sharing candidate group based on the accommodation requests, said accommodation sharing candidate group being identified by a group identification (ID), said group ID being associated with a plurality of member identifications (IDs), and said plurality of member IDs identifying two or more of the plurality of clients,
wherein the forming an accommodation sharing candidate group comprises storing member information associated with each of the plurality of member IDs, said member information associated with each of the plurality of member IDs including information on an arrangement/equipment defect penalty charge for a lodging offered for rental, an arrangement/equipment defect penalty charge for a lodging to be rented, and a bank account associated with the respective member ID,
said method further comprising:
setting the accommodation sharing candidate group as an accommodation sharing group in response to confirming online that for each of the plurality of member IDs, the arrangement/equipment defect penalty charge for the respective lodging to be rented is deposited to a bank account designated by an administrator; and
if an alarm message is received from a client identified by a particular member ID associated with the group ID of the accommodation sharing group, said alarm message notifying that a defect is present in an arrangement or equipment of the respective lodging to be rented, and if a message including identification information identifying the particular member ID is received from an administrator terminal or a message including administrator identification information is received from the client identified by the particular member ID, controlling the arrangement/equipment defect penalty charge for the respective lodging to be rented to be deposited online to the bank account associated with the particular member ID.
